(19) United States
(12) Patent Application Publication
(10) Pub. No.: US 2010/0067564 A1
(43) Pub. Date: Mar. 18, 2010

(54) Time Multiplexed Non-Coherent Multipath Search Method and Apparatus

(75) Inventor: Benyuan Zhang, Drexel Hill, PA (US)

Correspondence Address: Robert D. Shedd, Patent Operations;THOMSON Licensing LLC, P.O. Box 5312, Princeton, NJ, 08543-5312, US

(73) Assignee: THOMASON LICENSING, BOULOGNE-BILLANCOURT (FR)

(21) Appl. No.: 11/989,978

(22) PCT Filed: Aug. 5, 2005
(86) PCT No.: PCT/US2005/027698

§ 371 Date: Feb. 4, 2008

(51) Int. Cl. H04B 1/707

(52) U.S. Cl. 375/148; 375/E01.002

(57) ABSTRACT

An apparatus for performing a multipath search including a plurality of time-multiplexed chip correlators, wherein each of the plurality of time-multiplexed chip correlators has a pipeline, and further wherein each of the plurality of time-multiplexed chip correlators has a accumulation time is described. A method is described for performing a multipath search including performing multipath search slot processing, determining if a current multipath searching slot is a last multipath searching slot, if the current multipath searching slot is not the last multipath searching slot, then repeating the performing step, if the current multipath searching slot is the last multipath searching slot, then initializing a multipath searching slot index, determining if an non-coherent accumulation has been completed if the accumulation has not been completed then repeating all steps and if the accumulation has been completed, then search results are sorted to locate energy peaks corresponding to multipath locations.

### FIELD OF INVENTION

The present invention relates in general to wireless communications and specifically to a method and apparatus for performing a multipath search.

### BACKGROUND OF THE INVENTION

The general problem addressed by this invention is how to identify the different multipath components in a received WCDMA signal. This function is typically handled by a block in the receiver called the Multipath Searcher.

The characteristics of a dynamic fading channel are that it will degrade the performance of a multipath searcher using long coherent integration times. Another problem resulting from the characteristics of quickly changing fading channels is that the results from the early portion of the search cannot be meaningfully compared to the results from the later portion of the search because the channel has changed significantly in the intervening time. It is assumed that the searcher correlators are not large enough to cover the required time span in one operation.

A conventional prior art multipath searcher searches the certain length of code space to find the energy peaks. This certain length of code space is called a multipath searching window. The searching window usually is several hundred chips long depending on the multipath profile. In order to achieve a desirable performance, an 8, 4, or 2 samples per chip resolution of the searcher is necessary. Additionally, a certain integration time is needed for every searcher point. This is dwell time D. Normally CDMA system chip rate is several MHz, for example, the chip rate for WCDMA is 3.84 MHz. Due to this high speed chip rate, it is impossible to process the data by means of software in real time. Usually, a bank of hardware correlators has to be used. If a multipath searcher has a 200 chip window and 4 sample per chip resolution, it will need 800 correlators. Usually, a pipeline method with a higher speed system clock is used to save hardware. The higher the clock rate, the more power is consumed by the system. In conventional approaches, correlators will be a large portion of the hardware resources required for the multipath searcher.

That is, the conventional approach employs a bank of correlators in the searcher and then runs the searcher over the certain code space (searching window). In order to locate all possible paths, it is necessary to consider the worst case. The longer the searching window is, the larger the bank of correlators. The control logic is very simple for this approach, but more hardware resources are needed. It is desirable to reduce hardware resource requirements and reduce power consumption.

### SUMMARY OF THE INVENTION

The present invention describes a method and architecture for implementing a multipath searcher block in a CDMA receiver that uses a time multiplexed non-coherent correlation method to significantly reduce the hardware resources needed to conduct multipath searching. Reducing the overall amount of hardware required further reduces power consumption. The method and apparatus of the present invention can be used for any CDMA based technology.

The present invention solves two problems caused by time multiplexed correlator design. First, the present invention searcher locates all possible multipath energy peaks at the same time within a limited time period to avoid comparing results from a different time period. Second, a robust time multiplexed non-coherent correlation method has been used to overcome the performance degradation caused by time-varying changes in the wireless channel over the correlation period.

An apparatus for performing a multipath search including a plurality of time-multiplexed chip correlators, wherein each of the plurality of time-multiplexed chip correlators has a pipeline, and further wherein each of the plurality of time-multiplexed chip correlators has an accumulation time is described. A method is described for performing a multipath search including performing multipath search slot processing, determining if a current multipath searching slot is a last multipath searching slot, if the current multipath searching slot is not the last multipath searching slot, then repeating the performing step, if the current multipath searching slot is the last multipath searching slot, then initializing a multipath searching slot index, determining if an integration has been completed if the integration has not been completed then repeating all steps and if the integration has been completed, then search results are sorted to locate energy peaks corresponding to multipath locations.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 is a general timing block diagram for a conventional multipath search.

FIG. 2 is a timing block diagram for the time multiplexed multipath search of the present invention.

FIG. 3 is a block diagram for the multipath search architecture of the present invention.

FIG. 4 is a flowchart for the multipath search of the present invention.

### DETAILED DESCRIPTION OF THE PREFERRED EMBODIMENTS

The present invention reuses a small bank of correlators to perform a multipath search within a multipath searching window in a time-multiplexed scheme. First, the results of the correlation are accumulated non-coherently. This overcomes a harsh wireless environment. A reasonable time for correlation is used, e.g., 256 chips for WCDMA case. Second, if the multipath searching window is N chips and the resolution is M samples per chip, then total searching size will be N*M points. If the system clock allows a P stage pipeline, then the total number of correlators needed are (N*M)/P. For example, N=256, M=4 and P=8, it will employ 128 correlators to perform the multipath searching. In the present invention, if 4 correlators are used (and re-used) instead of 128, hardware usage will be reduced. In general, Y correlators will be used instead of (N*M)/P. The necessary condition is that N*M/P is an integer multiple of Y. Thus, the hardware resource savings is (N*M)/P/Y. Third, the multipath searching method is very generic. Y correlators will cover Y*M/P chips. The bank of correlators for (Y*M)/P chips will be used one by one for all N chips in the multipath searching window. After one pass, a non-coherent accumulation method is used to repeat the procedure until the multipath searcher dwell time is met.

Y needs to be chosen so that the channel is quasi-static over the time required to complete the multipath search. For a typical situation, 256 chip window (N) with 4 samples per chip (M) and clocking at 8 times the sample rate (P stage pipeline) would mean that typically 128 correlators would be required. Y is a divisor of 128. That is, (N*M)/P is an integer multiple of Y. It is likely that Y will be 16 or 32, allowing a hardware savings factor of 8 or 4, and requiring the channel be quasi-static over 8 or 4 slots. The slot time is about 667 microseconds, consequently, the channel dynamics should be quasi-static over between 2.7 to 5.3 milliseconds. The non-coherent accumulation method reduces the sensitivity to channel changes. The selection of Y is optimized through simulation. Y is a design parameter and is thus, selected permanently—in an IC design, once Y is set, it is not changed.

The pipeline is pre-determined based on the system clock rate. The accumulation time, the searching resolution and the dwell time are programmable.

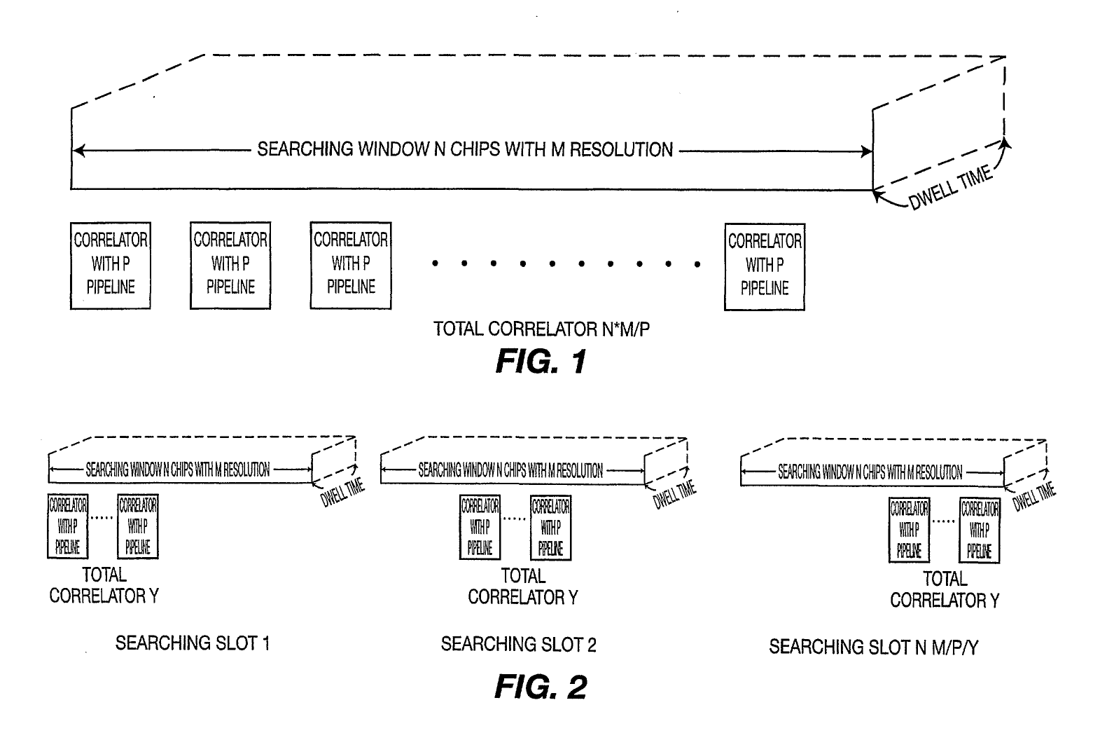

FIG. 1 shows a conventional multipath searcher timing diagram. (N*M)/P correlators are needed to fulfill the multipath searcher tasks.

In the FIG. 2, the timing diagram of the time-multiplexed multipath searcher of the present invention is shown. Y correlators are used here instead of (N*M)/P. Y must be chosen large enough to keep the time-multiplexed multipath searching procedure fast enough to track the worst case dynamic channel. Typically, the worst case situation is handover/handoff, which is actually 256 chips. Every multipath searching procedure is called a searching slot. The total number of multipath searching slots is (N*M)/P/Y. In every multipath searching slot, the multipath searcher will do integration for a duration of L chips. Accumulation is usually 256 chips, which is one symbol. It is possible to accumulate 512 chips, which is two symbols or 128 chips, which is ½ symbol. Correlation energy will be integrated over the dwell time.

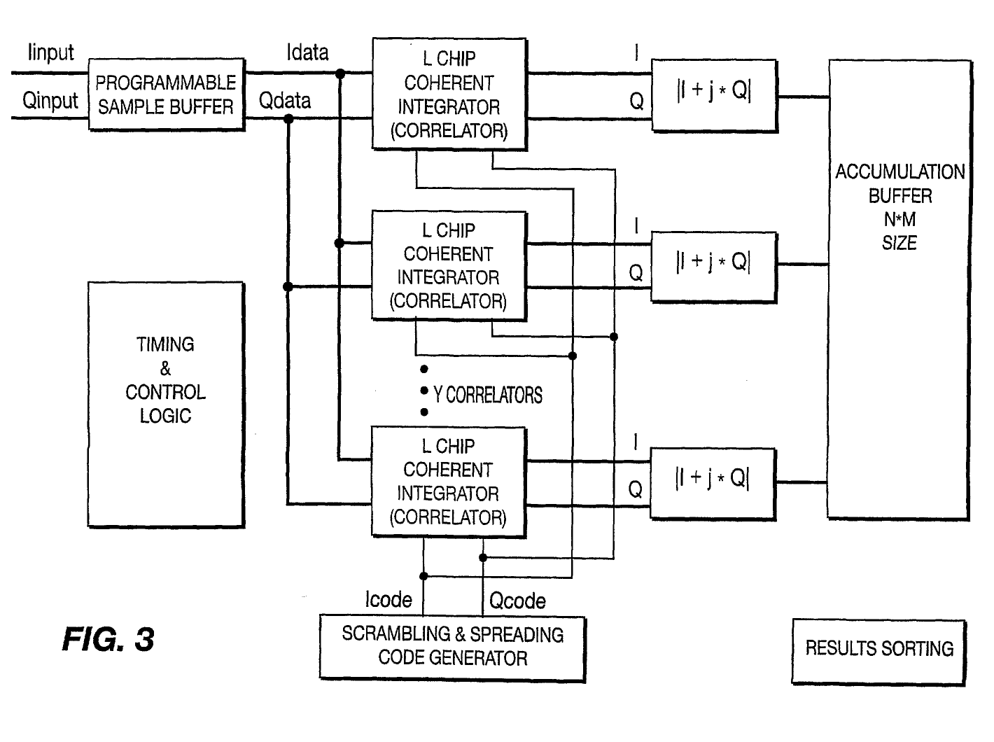

The multipath searcher architecture block diagram of the present invention is shown in FIG. 3. There are two input data streams, Iinput and Qinput, which are oversampled at S times the chip rate. The resolution M can be a sample rate less than or equal to S. A programmable sample buffer 305 decimates input data and prepares them for individual correlators (establishing a resolution of M samples per chip). Each of the Y correlators 310a, 310b, . . . 301z has a P stage pipeline. Their correlation time L is programmable. The scrambling and spreading code generator produces local copies of the scrambling and spreading codes being received. The code phases and timings are time-shifted versions of the same code. These time-shifted codes are synchronized to the received signal, and the correlators match time-shifted versions of scrambling and spreading codes in the received signal, the time shift indicating the difference in path length of the various multipaths received. The magnitude of the output of the correlators is computed in blocks 315a, 315b, . . . 315z. The magnitude computation blocks 315a, 315b, . . . 315z coupled to the time-multiplexed chip correlators make the time-multiplexed chip correlators non-coherent. These results will be accumulated in the (N*M) Accumulation Buffer 320. All the timing and control is controlled by the Timing & Control Logic Block 325. When the dwell time is completed, the resultant accumulation will be sorted in block 330 to find the energy peaks, which are the multipath locations. Sorting could be done in hardware or software.

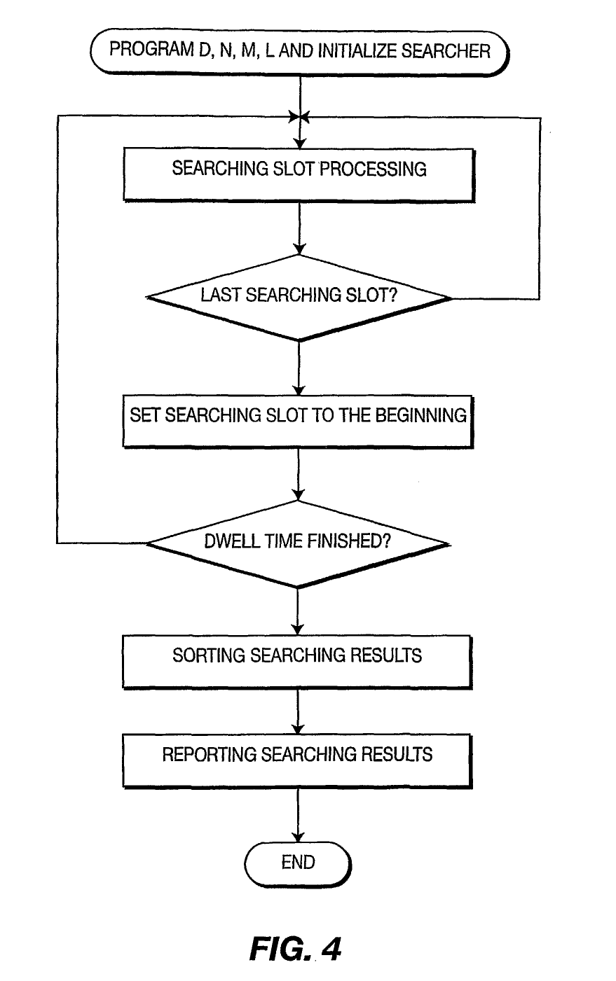

FIG. 4 is the flow chart for the multipath searcher of the present invention. At 405, the multipath searcher is initialized and dwell time D, resolution M, chips N and correlation time L are programmed. Multipath searching slot processing is performed at 410. A determination is made at 415 if the current multipath searching slot is the last multipath searching slot. If the current multipath searching slot is not the last multipath searching slot then step 410 is repeated. If the current multipath searching slot is the last multipath searching slot then the multipath searching slot index is set to the beginning (re-initialized) at 420. A determination is made at 425 if the dwell time (integration) is finished. If the dwell time is not finished then the above steps 410-420 are repeated. If the dwell time (integration) is finished then the search results are sorted at 430 to find the energy peaks, which are the multipath locations. Multipath search results are reported at 435. The integration time, the multipath searching resolution, the multipath searching window and the dwell time are programmable. The integration time is based on channel conditions and multipath delay profiles.

It is to be understood that the present invention may be implemented in various forms of hardware, software, firmware, special purpose processors, or a combination thereof, for example, within a mobile terminal, access point, or a cellular network. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. An apparatus for performing a multipath search comprising a plurality of time-multiplexed chip correlators, wherein each of said plurality of time multiplexed chip correlators has a pipeline, and further wherein each of said plurality of time-multiplexed chip correlators has an accumulation time and further wherein each of said plurality of time-multiplexed chip correlators are reused for each searching slot.

2. The apparatus according to claim 1, wherein said pipeline is pre determined based on a system clock rate.

3. The apparatus according to claim 1, wherein each of said plurality of time-multiplexed chip correlators receives data at a searching resolution for each chip.

4. The apparatus according to claim 3, wherein said searching resolution is programmable.

5. The apparatus according to claim 3, wherein said data includes real and imaginary values.

6. The apparatus according to claim 1, wherein each of said plurality of time-multiplexed chip correlators receives scrambling and spreading codes.

7. The apparatus according to claim 6, wherein said scrambling and spreading codes include time-shifted versions of said scrambling and spreading codes synchronized to a received signal and wherein said plurality of time-multiplexed chip correlators match said time-shifted version of said scrambling and spreading codes in said received signal, said time-shift indicating a difference in path lengths of various multipath signals received.

8. The apparatus according to claim 1, wherein each of said plurality of time-multiplexed chip correlators further comprises a corresponding magnitude computation unit which receives output from one of said plurality of timemultiplexed chip correlators and computes a magnitude of said output of its corresponding time-multiplexed chip correlator.

9. The apparatus according to claim 8, wherein said output of each of said plurality of time-multiplexed chip correlators includes real and imaginary values.

10. The apparatus according to claim 8, further comprising an accumulation buffer.

11. The apparatus according to claim 10, wherein said accumulation buffer operates over a dwell time.

12. The apparatus according to claim 11, wherein said dwell time is programmable.

13. The apparatus according to claim 3, further comprising a sample buffer for oversampling multipath signal data received and decimating said oversampled multipath signal data producing said data for said plurality of timemultiplexed chip correlators at said searching resolution.

14. The apparatus according to claim 1, wherein said accumulation time is programmable.

15. The apparatus according to claim 1, further comprising a results sorting unit for locating energy peaks corresponding to multipath locations.

16. The apparatus according to claim 1, wherein said apparatus is a mobile terminal.

17. A method for performing a multipath search, said method comprising:
performing multipath search slot processing by reusing time-multiplexed chip correlators for each searching slot;
determining if a current multipath searching slot is a last multipath searching slot;
repeating said performing step, in response to said current multipath searching slot not being said last multipath searching slot;
initializing a multipath searching slot index, in response to said current multipath searching slot being said last multipath searching slot;
determining if an integration has been completed;
repeating all steps, in response to said integration not being completed, and
sorting search results to locate energy peaks corresponding to multipath locations, in response to said integration being completed.

18. The method according to clam 17, further comprising initializing a multipath searcher.

19. The method according to claim 18, wherein said initializing step includes programming an integration time.

20. The method according to claim 18, wherein said initializing step includes programming a multipath searching resolution.

21. The method according to claim 18, wherein said initializing step includes programming multipath searching window.

22. The method according to claim 18, wherein said initializing step includes programming a dwell time.

23. The method according to claim 19, wherein said integration time is based on channel conditions and multipath delay profiles.

24. The method according to claim 17, further comprising reporting search results.

25. The apparatus according to claim 1, further wherein a search resolution is reduced.
